(19) United States
(12) Patent Application Publication
(10) Pub. No.: US 2017/0351422 A1
(43) Pub. Date: Dec. 7, 2017

(54) TRANSPORTATION MEANS, USER INTERFACE AND METHOD FOR OVERLAPPING THE DISPLAY OF DISPLAY CONTENTS OVER TWO DISPLAY DEVICES

(71) Applicant: VOLKSWAGEN AG, Wolfsburg (DE)

(72) Inventors: Holger WILD, Berlin (DE); Nils KÖTTER, Braunschweig (DE)

(21) Appl. No.: 15/538,516

(22) PCT Filed: Dec. 18, 2015
(86) PCT No.: PCT/EP2015/080522

§ 371 Date: Jun. 21, 2017

(30) Foreign Application Priority Data
Dec. 22, 2014 (DE) 102014226760.9
Jan. 2, 2015 (EP) 15150029.5

(51) Int. Cl. G06F 3/0488; B60K 37/06; G09G 5/12

(52) U.S. Cl. CPC G06F 3/04883; G09G 5/12; B60K 37/06; G09G 2340/145; B60K 2350/352; B60K 2350/2069; B60K 2350/106; B60K 2350/1052; B60K 2350/1032; B60K 2350/1012; B60K 2350/1004; G09G 2354/00; G09G 2380/10; B60K 2350/2008

(57) ABSTRACT

The invention relates to a transportation means, a user interface and a method for overlapping the display of display contents of a user interface of a transportation means. The method comprises the steps: displaying first display contents on a first display device of the transportation means; picking up a pre-defined user entry with respect to the first display contents and in response thereto; extending a first surface associated with the first display contents on a second display device of the transportation means.

### CROSS-REFERENCE TO RELATED APPLICATIONS

This application is a national stage entry under 35 USC §371 of PCT International Application No. PCT/EP2015/080522, filed Dec. 18, 2015, and claims the benefit under 35 USC §119(e) to German Patent Application No. 102014226760.9, filed Dec. 22, 2014 and to European Patent Application Number 15150029.5, filed Jan. 2, 2015.

### SUMMARY

The present disclosure relates, in a first aspect (“finger strip”) to an infotainment system, a transportation means (or transportation vehicle) and an apparatus for operating an infotainment system of a transportation means; and, in a second aspect (“use of the finger strip”), to a transportation means, a user interface and a method for overlapping the display of display contents over two display devices by means of a user input made using such a finger strip.

### BRIEF DESCRIPTIONS OF THE DRAWINGS

Exemplary embodiments of the invention are described in detail below with reference to the accompanying drawings, in which:

FIG. 1 shows a schematic overview of components of an exemplary embodiment of a transportation vehicle according to the present disclosure having an exemplary embodiment of an apparatus according to the disclosure;

FIG. 2 shows a perspective drawing of an exemplary embodiment of an apparatus according to the disclosure;

FIG. 3 shows a detailed view of a section of the exemplary embodiment shown in FIG. 2;

FIG. 4 shows a plan view of an exemplary embodiment of a detection unit which is used according to the present disclosure and has a multiplicity of capacitive antennas;

FIG. 5 shows a basic outline illustrating an exemplary embodiment of an apparatus according to the present disclosure, in which a display unit having a touch-sensitive surface provides a display area, a detection unit and a light outlet of an apparatus according to the present disclosure;

FIG. 6 shows a schematic view of components of an exemplary embodiment of a transportation means according to the invention having an exemplary embodiment of a user interface according to the present disclosure;

FIG. 7 shows an illustration of a first user operating step when operating an exemplary embodiment of a user interface according to the present disclosure;

FIG. 8 shows an illustration of a second user operating step when operating an exemplary embodiment of a user interface according to the present disclosure;

FIG. 9 shows the result of the user interaction illustrated in connection with FIGS. 7 and 8;

FIG. 10 shows an illustration of an alternative exemplary embodiment of a user interface configured according to the present disclosure;

FIG. 11 shows an illustration of the result of an extension according to the invention of the first display contents illustrated in FIG. 10;

FIG. 12 shows a third exemplary embodiment of a user interface according to the present disclosure;

FIG. 13 shows the result of an extension according to the invention of the first display contents illustrated in FIG. 12; and

FIG. 14 shows a flowchart illustrating steps of an exemplary embodiment of a method according to the present disclosure.

### DETAILED DESCRIPTION OF THE DISCLOSED EMBODIMENTS

The present disclosure relates to an infotainment system, transportation vehicle, and apparatus for operating an infotainment system of a transportation means

The present invention relates to a transportation means, an infotainment system and an apparatus for operating an infotainment system of a transportation vehicle. In particular, the present disclosure relates to a possibility for inputting infinitely variable input values by means of swiping gestures without the user having to look at the user interface in order to make specific inputs.

On the basis of the prior art cited above, an object of the present disclosure is to integrate a convenient input device for swiping gestures in the interior of a transportation vehicle. Another object of the present disclosure is to make feedback for a user of such a system intuitively comprehensible.

The object identified above is achieved, according to the present disclosure, by means of an apparatus for operating an infotainment system of a transportation means, sometimes called a transportation vehicle. The apparatus comprises a linear or curved finger strip which is set up to haptically (longitudinally) guide a user's finger. In other words, a one-dimensional track is predefined for the user's finger. Such a track has, in particular, a concave and/or convex (partial) structure transverse to its longitudinal direction, which structure can be haptically detected by a user during a swiping gesture and can be used to orientate the finger on the finger strip. A detection unit for detecting swiping gestures carried out on the finger strip is also provided. The detection unit may detect (for example capacitively) a movement of human tissue on the finger strip and can convert it into electrical signals. An evaluation unit is provided for the purpose of processing detected swiping gestures (or signals produced by the latter) and can be in the form of a programmable processor, a microcontroller, a nanocontroller or the like. The apparatus also has a linear light outlet which extends at least approximately completely along the finger strip. The light outlet may be a partially transparent plastic and/or glass body and/or sintered body through which a luminous means behind it can distribute light in the direction of the user. In response to a user gesture detected by means of the detection unit, the apparatus can acknowledge the user gesture by means of a light signal emitted from the light outlet. For example, a function which has been started can be acknowledged by means of a light pattern associated with the function. The light pattern may also have one or more colors which are uniquely associated with the function which has respectively been started. Irrespective of a successful start of a function associated with the gesture, the actuation of the apparatus can also be acknowledged by outputting a corresponding light signal. In the case of a swiping gesture in particular, a shimmer (also “glow” or “corona”) can be produced around the finger(s) and moves with the finger, as a result of which the user is informed of the manner in which the apparatus has detected his gesture. A user gesture can also already be understood as meaning an approach or placement of one or more fingers, one or more running lights being produced along the light outlet (for example starting at its edge(s)) in the direction of the finger(s), with the result that even untrained users are provided with an intuitively comprehensible signal indicating that they have just found or used an input interface.

The finger strip may be provided for horizontal arrangement, for example. This may provide the advantage that a ledge or a support for a finger is formed in the vertical direction, as a result of which accelerations produced in the vertical direction (for example when driving over a bump or a pothole) do not move the user's finger from an intended area in front of the finger strip. The operation of the apparatus becomes particularly intuitive if the finger strip is arranged above and/or below a display area in a transportation means. In this manner, the apparatus or the finger strip provided is in a strong context of the display areas and is intuitively understood as part of a user interface. Particularly pleasant and self-explanatory haptics result if the finger strip is in the form of a channel-shaped or trough-shaped longitudinal groove which follows a surface of a (flat or curved) screen, for example.

The light outlet is preferably embedded in the finger strip, as a result of which the emitted light signal is particularly strongly associated with the user gesture. In other words, the light outlet is also brushed during operation of the finger strip, with the result that the acknowledging light signal appears to be arranged in the immediate vicinity, and in particular, also below the user's respective finger.

A suitable possibility for realizing the acknowledging light signals is to arrange a light source behind the light outlet, which light source comprises individual luminous means (for example light-emitting diodes, LEDs) which have a particularly fast response speed with respect to electrical signals controlling them. This enables a particularly precise output of light signals acknowledging the user gesture. In particular, a translucent (also colloquially “milky”) element for homogenizing light distributed by the light outlet may be provided. In this manner, the translucent element ensures that the irradiated light is diffused in the direction of the user, as a result of which the inhomogeneous light source appears in an optically more attractive form and precise positioning of the light signal is nevertheless possible.

The variety of possible inputs becomes particularly clear to the user if the finger strip is bounded on both sides by optically and/or haptically delimited end regions in order to form key fields. For example, webs may be provided transverse to the longitudinal extent of the finger strip and can be clearly felt by the user. Additionally or alternatively, it is possible to provide grooves transverse to the longitudinal direction of the finger strip in order to optically and haptically delimit a swiping region between the end regions with respect to the key fields. The key fields can also be operated in this manner substantially without the apparatus being optically detected by the user. This may contribute to traffic safety during operation of the apparatus. For example, repeated tapping inputs with respect to one of the key fields can be used to change a function associated with the swiping region (“toggling”). Possible functions which can be “connected” by means of the key fields are explained in the further course of the present description. For example, a function selected for the swiping region can also be assigned to the swiping region for future operating steps by means of a long-press gesture. This makes it possible to permanently assign a function desired by the user to the swiping region.

The light outlet may preferably be set up to output a predefined different light color in the region of the key fields irrespective of a current light color in all other regions of the finger strip. A corresponding situation applies to a light intensity. In other words, the regions of the light outlet in the end regions are preferably delimited with respect to the swiping gesture region of the finger strip in an optically impermeable manner. For example, three translucent components of the light outlet may be interrupted by two opaque (that is to say optically “impermeable”) structures in the region of the optical and/or haptic delimitation. For example, these optical interruptions may project from a surface of the finger strip in such a manner that they ensure that the end regions are haptically bounded. Optical crosstalk of light is preferably at least avoided by not superimposing translucent elements on the opaque structures in the direction of the user. A particularly homogeneous surface can be achieved, however, by virtue of a completely transparent element forming the surface of the finger strip.

The detection unit may have a linear arrangement of a multiplicity of capacitive antennas which are arranged beside one another in a region behind the finger strip in the main direction of extent (longitudinal direction) of the finger strip. In other words, the individual capacitive antennas follow the linear shape of the finger strip, with the result that a particularly large number of different input positions on the finger strip can be resolved by the detection unit and can be reported to the evaluation unit. In comparison with capacitive surfaces of touch-sensitive screens, the individual capacitive antennas may provide the advantage of more flexible designability with respect to sensitivity and range. For example, the detection unit cannot only detect touch but can also detect when a user approaches without making contact with the finger strip and can report it to the evaluation unit.

For example, the apparatus according to the present disclosure may have a display unit having a touch-sensitive surface and a linear or curved haptic barrier on the display unit. The barrier is used to delimit a display area of the display unit with respect to an edge region of the display unit which is intended for the configuration of a finger strip according to the present disclosure. A segment of the touch-sensitive surface of the display unit which is arranged in the region of the finger strip is therefore used as a detection unit for detecting pressure/tapping and swiping gestures of a user. Accordingly, a segment of the display unit which is arranged in the region of the finger strip can form the light outlet of the apparatus. In other words, the light outlet is in the form of a linear segment of a self-illuminating display unit. As a result of the haptic barrier, the display unit can provide the display area, on the one hand, and the detection unit and the light outlet of the apparatus, on the other hand, even though the display unit can be produced as a one-piece element. This increases the stability of the apparatus, reduces the number of components, dispenses with mounting operations and reduces costs of production. Moreover, one-piece components avoid problems of creaking, rattling and unwanted ingress of dirt during vehicle construction, thus preventing malfunctions.

A proximity sensor system may preferably also be provided, the evaluation unit being set up to acknowledge a gesture detected by means of the proximity sensor system by means of a light signal emitted from the light outlet. In other words, not just touch interaction between the user and the finger strip is acknowledged, but rather a light signal is already output in response to the user approaching the finger strip in order to inform the user that the possibility of touch input with the apparatus exists and what such interaction could look like. This can be effected, for example, by means of light sequences and/or flashing patterns, as a result of which the user is encouraged to input swiping or multi-touch gestures.

The evaluation unit is preferably set up to evaluate a first predefined gesture on the finger strip for adapting a volume of media playback. The first gesture may be, for example, a swiping gesture with a single finger. Alternatively or additionally, the evaluation unit is set up to evaluate a second predefined gesture on the finger strip for adapting a volume of a voice output of the infotainment system. The second gesture may be, for example, a swiping gesture with exactly two fingers (multi-touch gesture). Alternatively or additionally, the evaluation unit may be set up to evaluate a third predefined gesture on the finger strip for adapting a volume of sounds or acoustic warning tones. The third gesture may be, for example, a multi-touch swiping gesture carried out using exactly three fingers. An association between the above-mentioned gestures and exemplary ranges of functions can be modified in any desired manner without departing from the scope of the present disclosure.

Respective advisory text and/or a respective advisory symbol can be output on a display unit of the apparatus depending on the type of gesture or the type of function started by the gesture.

Alternatively or additionally, a light signal output via the light outlet may acknowledge the function and type of detected gesture independently of one another. For example, the type of gesture can be illustrated or acknowledged by one or more positions of increased light intensity. The functions being operated can be illustrated using different colors. For example, if an air-conditioning function is operated by means of a swiping gesture, the light signal can be changed in the direction of blue or in the direction of red depending on a decrease or an increase in a desired temperature. If the function is a change in volume, it is possible to change from a white light in the direction of red light if the volume is increased or, the other way around, from a red light color to white light if the volume is decreased. It goes without saying that light of a first color can be applied to the light outlet approximately completely in order to illustrate how the function is adapted, whereas a second color is selected for light distributed in the region of the user's finger, thus acknowledging the detected gesture (for example irrespective of an adapted function).

The evaluation unit may also be set up, in response to a predefined period elapsing after an end of a gesture detected by means of the detection unit, to adapt a light signal emitted from the light outlet to a current setting of the ambient light of the transportation means. In other words, the light outlet and the luminous means arranged behind the latter can be used to support an ambient light concept if the finger strip according to the present disclosure is acutely not used to receive user gestures or acknowledge them. The predefined period, after which a changeover is automatically made to the ambient light mode after a user interaction, may be, for example, a minimum period in the form of integer multiples of one second in the range between one second and 10 seconds. In this manner, the apparatus according to the present disclosure is used in an even more versatile manner for optically appealing interior design which can be operated intuitively and comfortably.

A second aspect of the present disclosure proposes an infotainment system for a transportation means, which infotainment system comprises an apparatus according to the first-mentioned aspect of the present disclosure. In other words, the apparatus according to the present disclosure is supplemented with ranges of functions, for example music playback and/or a navigation function, in one configuration. Accordingly, heating/air-conditioning ranges can also be adapted and illustrated using the apparatus according to the invention. The features, combinations of features and the advantages resulting therefrom correspond to the first-mentioned aspect of the present invention, with the result that reference is made to the statements above in order to avoid repetitions.

A third aspect of the present disclosure proposes a transportation means having an infotainment system according to the second-mentioned aspect of the present disclosure or an apparatus according to the first-mentioned aspect of the present disclosure. The transportation means may be, for example, an automobile, a transporter, a truck, a motorcycle, an aircraft and/or a watercraft. Reference is also made to the statements above with respect to the features, combinations of features and the advantages resulting therefrom of the transportation means according to the present disclosure in order to avoid repetitions.

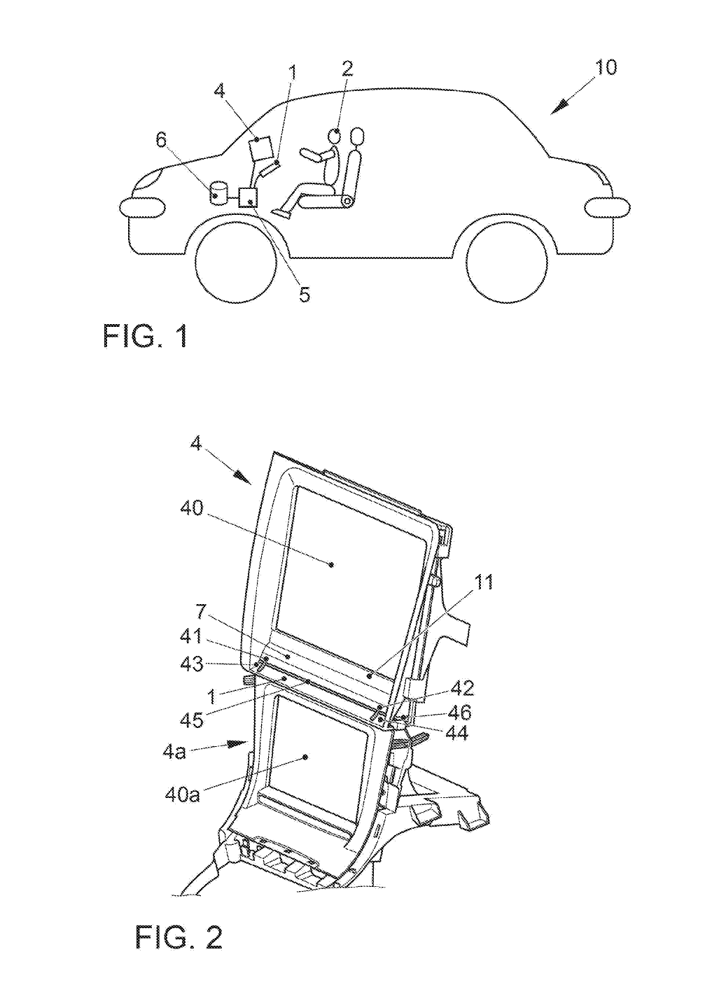

FIG. 1 shows an automobile 10 as a transportation means or transportation vehicle, in which a screen 4 as a display unit is connected to an electronic control unit 5 as an evaluation unit using information technology. A finger strip 1 arranged horizontally below the screen 4 is connected to the electronic control unit 5 using information technology for the purpose of detecting user gestures and for optically acknowledging the latter by means of light signals. A data memory 6 holds predefined references for classifying the user gestures and is used to define light signal patterns associated with the classified user gestures. A user 2 extends his arm substantially horizontally in order to carry out a swiping gesture on the finger strip 1. Without a configuration according to the present disclosure of the finger strip 1, vertical accelerations of the automobile 10 would result in the user occasionally missing the finger strip 1. In addition, the user 2 would have to direct his attention to the finger strip 1 in order to cleanly position his finger on the latter. According to the present disclosure, these operations may be omitted since the finger strip 1 has a ledge-like structure for guiding the finger of the user 2.

FIG. 2 shows an exemplary embodiment of an apparatus according to the present disclosure having two screens 4, 4a which are provided substantially above one another for arrangement in a center console or a dashboard of a transportation means. The display areas 40, 40a of the screens 4, 4a are separated, from the top downward in order, by a web-shaped frame part 11 as a haptic barrier, an infrared LED strip 7 as a proximity sensor system and a concave finger strip 1 in which a linear light outlet 45 which follows the longitudinal direction of extent of the finger strip 1 is embedded. Distal regions 43, 44 of the finger strip 1 are delimited or marked with respect to a central swiping gesture region of the finger strip 1 as buttons by means of web structures 41, 42 oriented perpendicular to the longitudinal direction of extent. The linear light outlet 45 is adjoined by a light guide 46 which extends substantially in the direction of travel and conducts light coming from the direction of travel in the direction of the user in order to generate acknowledging light signals.

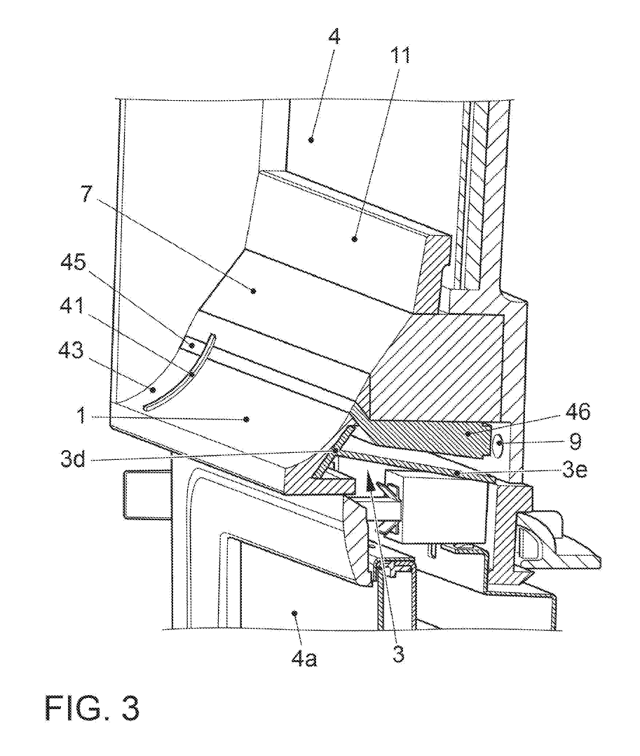

FIG. 3 shows a detailed view of the exemplary embodiment of an apparatus according to the present disclosure, as illustrated in FIG. 2. In this view, an LED 9 is provided, by way of example, as a luminous means of a light source on the light guide 46 in the direction of travel, through which LED a narrow but diffusely bounded region of the light exit 45 shines in the light of the LED 9. A carrier 3d of a capacitive detection unit 3 is arranged just below the surface of the finger strip 1 and is mechanically and electrically connected to a circuit board 3e. The circuit board 3e carries electronic components (not illustrated) for operating the detection unit 3.

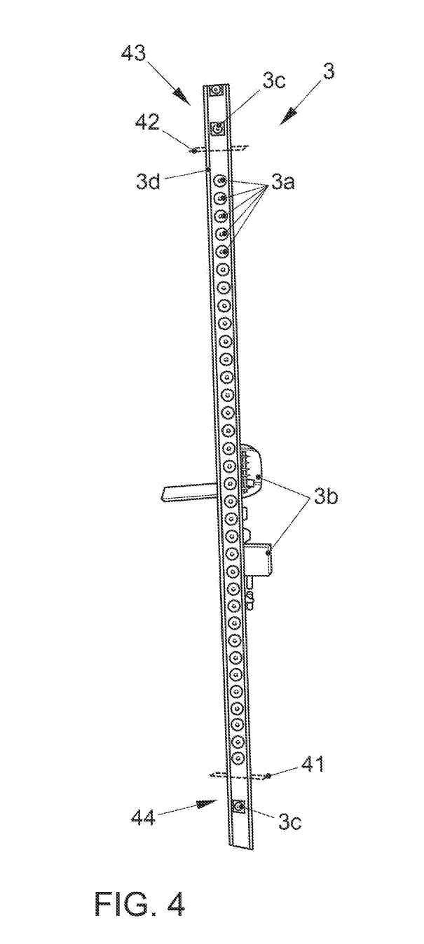

FIG. 4 shows an exemplary embodiment of a detection unit 3, as presented in FIG. 3. In the plan view according to FIG. 4, capacitive antennas 3a which are arranged beside one another in a linear manner can be seen on the carrier 3d, which antennas each have a disk-shaped form and are arranged equidistantly with respect to one another. Webs 41, 42 illustrated using dashed lines are used to indicate end regions 43, 44 each having a square capacitive antenna 3c for receiving pressure and/or tapping and/or long-press gestures. Electronic components 3b are arranged on the circuit board (reference symbol 3e) in FIG. 3 and are provided for the purpose of operating the antennas 3a, 3c.

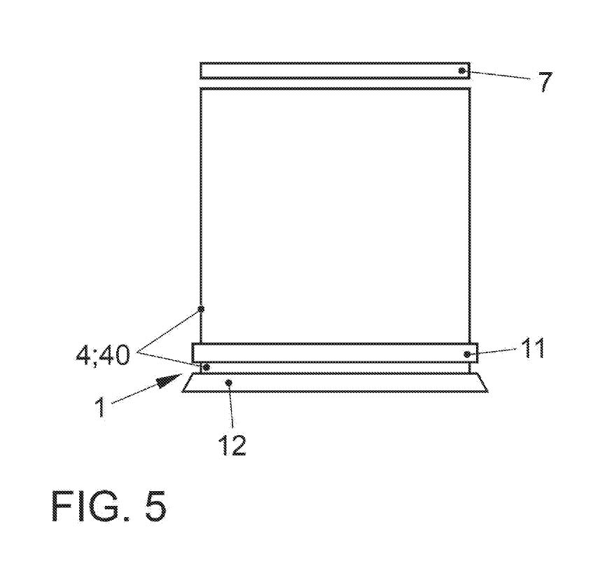

FIG. 5 shows a basic sketch of an alternative exemplary embodiment of an apparatus according to the present disclosure for operating an infotainment system. A proximity sensor system 7 for detecting when a user's hand approaches the apparatus is provided above a screen 4 having a display area 40. A substantially horizontal web 11 on the screen 4 bounds a narrow surface region of the display area 40, which is associated with a finger strip 1, from a main display region of the display area 40. The screen 4 is in the form of a touchscreen (“touch-sensitive display unit”), as is known in the prior art. However, in order to implement an apparatus according to the present disclosure, a display region 40 arranged above the web 11 is controlled in an entirely different manner to a region which is arranged below the web 11 and forms the detection unit and the light outlet of the apparatus. In other words, a one-piece screen 4 in the form of a touchscreen is provided, the lower edge of which forms the detection unit and the light outlet of the apparatus according to the invention. The finger strip 1 is delimited toward the bottom by a substantially horizontal ledge 12 for placing a finger and guiding it when carrying out a swiping gesture.

A transportation vehicle, user interface and method for overlapping the display of display contents over two display devices are disclosed in this paper.

The present disclosure relates to a transportation means (sometimes called a transportation vehicle), a user interface and a method for overlapping the display of display contents of a user interface over two display devices of a transportation means. In particular, the present disclosure relates to intuitive user operating steps for extending a display area associated with display contents.

An object of the present invention is to support and improve the orientation of a user when a plurality of display devices are flexibly used in a transportation means.

The object identified in the present case is achieved, according to the present disclosure, by means of a user interface and a method for overlapping the display of display contents of a user interface of a transportation means. The present disclosure is based on the knowledge that logically anchoring a range of functions or a range of information to a single display device can improve the orientation of the user. The transportation means may be, for example, an automobile, a truck, a motorcycle, an aircraft and/or a watercraft. In a first step, first display contents are displayed on a first display device (for example a screen) of the transportation means. The display device may also be configured to receive user inputs and, for this purpose, may have a touch-sensitive surface for resolving single-finger or multi-finger gestures, for example. The display contents are understood as meaning a region which is associated with a predefined range of functions of the user interface or the transportation means. In particular, vehicle functions, entertainment functions and information relating to a predefined subject area can constitute the first display contents as an optical cluster. The display contents may be in the form of a window, for example with a frame, and/or may be optically highlighted with a non-transparent or partially transparent background color. The display contents may have, for example, operating areas and/or buttons which can be used to influence functions of the display contents by means of user inputs. A predefined user input with respect to the first display contents is then received. The user input is used by the user to express the desire to increase the display area for the display contents and, in particular, to display additional information/input elements within the display contents. For this purpose, an area associated with the first display contents is extended on a second display device of the transportation means in response to the received user input. For example, the display contents previously displayed solely on the first display device can be proportionately extended to the second display device in this case, additional information and/or operating elements being added to the display contents. However, this does not exclude the fact that the second display device may have already reserved and/or used a region for the purpose of displaying the display contents before the predefined user input with respect to the display contents was received. The extension proposed can therefore signify display of parts of the display contents for the first time or additional display of contents of the display contents. In any case, the second display device is occupied by an increased region of the display contents after the extension. This enables (temporarily) extended use of the second display device for the display contents without the user losing the optical relationship between the display contents and the first display device.

Even after the display contents have been extended to the second display device, the first display device is preferably used to (proportionately) display the display contents. This part of the display contents which has remained on the first display device is used as an optical and logical “anchor” for the display contents. In particular, the display of the display contents displayed on the first display device is not influenced by the extension. At least the area associated with the display contents on the first display device is preferably retained in terms of the size and/or shape. This does not exclude individual elements within the display contents having a different size and/or a different shape and/or a different position, the latter of which can also be arranged on the second display device, after the display contents have been extended to the second display device. This makes it possible to flexibly use different display devices while retaining a logical relationship between the display contents and the first display device.

Whereas the above-mentioned display contents (“first display contents” below) are extended on the second display device, second display contents already previously displayed on the second display device can be continuously (proportionately) displayed. In other words, the first display contents are not extended to the entire area of the second display device and are still surrounded by portions of the second display contents after the extension. This intensifies the user's impression that the extension of the first display contents to the first display device can be understood as being only temporary and therefore intensifies the logical relationship between said contents and the first display device.

In order to intensify a delimitation (or to counteract the impression of the first display contents and the second display contents being merged), the first display contents may be characterized by an edge which appears to be optically closed with respect to the second display contents on the second display device. In particular, the edge may be configured by a closed edge line between the first display contents and the second display contents. A simple and optically highly effective measure may involve providing the first display contents with a different background color to the second display contents. In particular, the background color of the first display contents may cover the second display contents (the background of the first display contents is therefore only incompletely transparent or not transparent at all). Alternatively or additionally, the first display contents may be delimited with respect to the second display contents by an optical emphasis of the edge line in the manner of a frame or a shadow on the second display contents. Alternatively or additionally, the second display contents may be displayed in a blurred and/or darkened manner and/or with lower contrast and/or in a reduced form (moved into the plane of the drawing) and/or with a lower saturation, in particular in a sepia or grayish color, after the extension in order to direct the optical focus on the operability of the first display contents and to nevertheless highlight the temporary character of the extension of the first display contents.

In order to reverse the extension of the first display contents to the second display device, a swiping gesture in the direction of the first display device may be provided, for example, which swiping gesture is carried out or detected, in particular, with respect to the extended display contents on the second display device, but at least with reference to the second display device. The swiping gestures carried out within the scope of the present disclosure can be carried out as touch inputs on a touch-sensitive surface of an input device (for example a touchscreen) and/or as (3-D) gestures freely carried out in space. Alternatively or additionally, a tapping gesture on the second display contents on the second display device or on a predefined region within the extended first display contents on the second display device can be provided as a control command for (at least proportionately) reversing the extension of the first display contents. In other words, in response to the above-mentioned user inputs, the area associated with the first display contents on the second display device is reduced. For example, an edge line of the first display contents which is moved as part of the extension can be moved in the direction of the first display device. Depending on the selected position of the edge line or the selected size of the area of the first display contents which is displayed on the second display device, the position and/or size and/or shape of the included information/operating elements can be dynamically adapted. This supports the best possible and flexible use of the first display contents and of the total available display area of the display devices of the transportation means.

A second aspect of the present disclosure proposes a user interface for a transportation means, which comprises a first display device (for example a screen, “secondary screen”), a second display device (for example a screen, “primary screen”), a detection unit for detecting user gestures (for example comprising a touch-sensitive surface and/or a capacitive input device and/or an optical detection device for resolving three-dimensional user gestures) and an evaluation unit (for example comprising a programmable processor, a microcontroller, a nanocontroller or the like). The first display device is set up to display first display contents. The detection unit is set up to receive a predefined user input with respect to the first display contents. The evaluation unit is set up, in response to the detection of the predefined user input, to extend an area associated with the first display contents on the second display device of the transportation means. The first display device may be in the form, for example, of a secondary screen for arrangement in a lower region of a dashboard (for example for the purpose of displaying and/or operating heating/air-conditioning ranges and/or displaying operating elements for influencing fundamental functions of media playback and/or route guidance, in particular). The second display device may be in the form, for example, of a larger matrix display (central information display) which is intended to be centrally arranged in a dashboard of a transportation means. The detection unit may have an infrared LED strip which can be used to detect approach gestures and other gestures carried out by a user freely in space. Alternatively or additionally, the detection unit may have a so-called “finger strip” for receiving mechanically guided swiping gestures by a user, as has been described, for example, in the patent application filed at the German Patent and Trademark Office by the applicant on Oct. 22, 2014 under the file reference 102014226760.9 and referred to above as the “first aspect finger strip”.

The first display device and the second display device can preferably be arranged behind one another or beside one another or below one another with respect to a first direction. For example, the first direction may be oriented substantially vertically, thus resulting in an arrangement of the display devices above one another (for example in the dashboard of the transportation means). Accordingly, the first direction may be oriented substantially horizontally, thus resulting in an arrangement of the display devices substantially beside one another (for example in the dashboard of a transportation means). The display devices may preferably have different sizes and/or different aspect ratios. This can support particularly comprehensive use of the area available in the dashboard.

The width of the first display device with respect to the first direction (that is to say the extent of the first display device transverse to the first direction) can be smaller than a corresponding width of the second display device with respect to the first direction. In other words, that display device to which the first display contents are originally assigned is narrower than the second display device. In this case, the area associated with the first display contents on the second display device is preferably extended only to the width of the first display device. In other words, the first display contents on the second display device remain restricted to the width of the first display device. This intensifies the logical and optical relationship between the first display contents and the first display device.

More preferably, an area associated with the first display contents on the first display device can be arranged closest to the second display device. In particular, the entire width of the first display device is associated with the first display contents. Accordingly, an area associated with the first display contents on the second display device can be arranged closest to the first display device. Areas which are adjacent to one another on the display devices therefore display the first display contents with the shortest possible distance at the joint between the display devices. In this manner, the first display contents are perceived in the best possible manner as a contiguous coherent and/or functional unit (also “window” or “tile”).

The user input for extending the first display contents on the second display device may be, for example, a swiping gesture in the direction of a center of the second display device. Such a swiping gesture is a particularly intuitive user input which can be carried out in a large region for the purpose of extending the first display contents. Alternatively or additionally, a tapping gesture on a button may be predefined for the purpose of extending the first display contents. The button may be displayed, for example, in a region of the second display device which is closest to the first display device or in a region of the first display device which is closest to the second display device. In other words, the button is preferably arranged at a location at which an edge line of the first display contents, which needs to be moved or newly arranged in the case of the extension, is currently situated.

A third aspect of the present disclosure proposes a computer program product which stores instructions which enable a programmable processor, for example an evaluation unit of a user interface to carry out the steps of a method according to the first-mentioned aspect of the present disclosure or enable the user interface to carry out this method. The computer program product may be in the form of a data memory (for example in the form of a CD, a DVD, a Blu-ray disc, a flash memory, a hard disk, RAM/ROM, a cache etc.

A fourth aspect of the present disclosure proposes a signal sequence representing instructions which enable a programmable processor (for example an evaluation unit of a user interface) to carry out the steps of a method according to a first-mentioned aspect of the present disclosure or set up the user interface to carry out this method. In this manner, the IT provision of the instructions is also protected for the case in which the memory means required for this purpose are outside the scope of the accompanying claims.

A fifth aspect of the present disclosure proposes a transportation means (for example an automobile, a transporter, a truck, a motorcycle, a watercraft and/or an aircraft) comprising a user interface according to the second-mentioned aspect of the present disclosure. Individual components or all components of the user interface may be permanently integrated, in particular, in the information infrastructure of the transportation means in this case. Mechanically permanent integration in the transportation means is also alternatively or additionally provided for individual components or all components of the user interface.

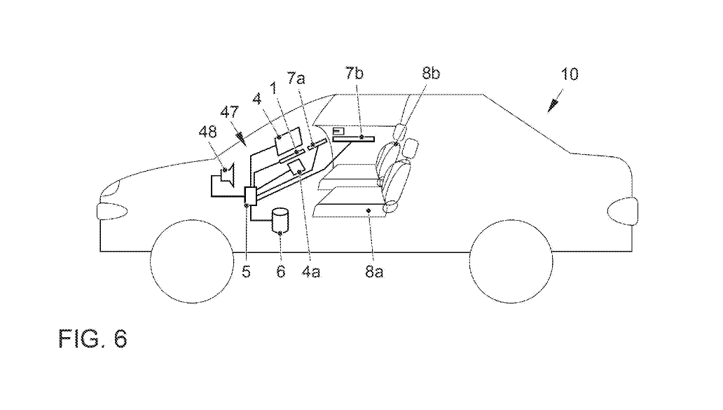

FIG. 6 shows an automobile 10 as a transportation means in which an exemplary embodiment of a user interface 47 has a small screen 4a as a first display device and a larger screen 4 arranged above the latter as a second display device. An infrared LED strip 3a is provided between the screens 4, 4a as a detection unit for detecting gestures freely carried out in space and, like the screens 4, 4a, is connected to an electronic control unit 5 as an evaluation unit using information technology. The electronic control unit is also connected to a data memory 6 which has references for predefined user inputs/gestures and computer program code for carrying out a method. The electronic control unit 5 is also connected to a loudspeaker 48 for outputting advisory and acknowledgement tones. The electronic control unit 5 can influence the distribution of light from ambient light strips 7a in the dashboard and ambient light strips 7b in the doors of the automobile 10 via additional control lines. A driver's seat 8a and a passenger seat 8b are intended to accommodate a driver and a passenger as users of the user interface 47.

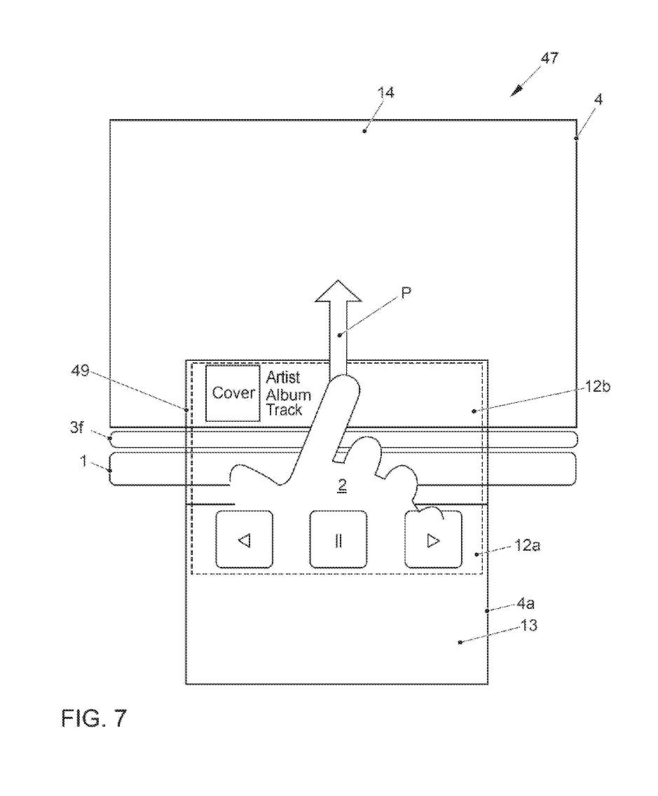

FIG. 7 shows a detailed view of the surface of a first exemplary embodiment of a user interface 47 according to the present disclosure. Heating/air-conditioning ranges are displayed in a lower region 13 on a smaller screen 4a as a first display device. A region 12a above this has buttons for pausing media playback and for selecting preceding and upcoming tracks/chapters. The region 12a is optically grouped with display elements in a region 12b on the screen 4 via a display area 49 (also “window” or “additional window”) as first display contents, thus resulting in the overlapping display of first display contents. A cover of an album currently being played back and information relating to the “artist”, “album title” and “track” are displayed in the region 12b. Screen contents 14 which are displayed independently of the region 12b as second display contents of the screen 4 can be topically selected independently of the contents of the display area 49. A finger strip 1 for the guided reception of swiping gestures by a user and an infrared LED strip 3a for detecting 3-D gestures from a hand of a user 2 are situated between the screens 4, 4a. In order to extend the display area 49, the index finger of the hand of the user 2 carries out a swiping gesture along the arrow P which starts in the region 12b and is oriented in the direction of the center of the screen 4.

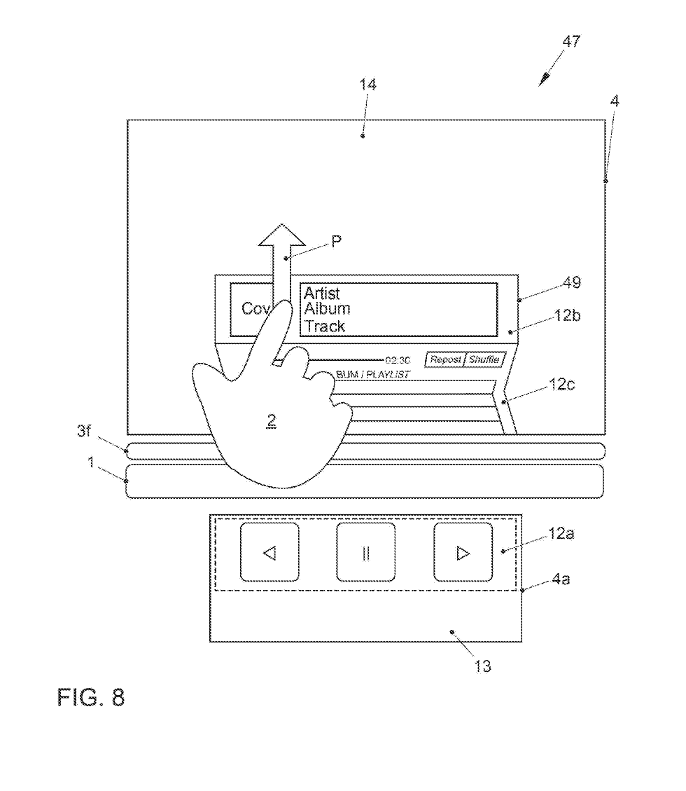

FIG. 8 shows an intermediate result of the swiping gesture by the hand of the user 2, which was started in FIG. 7. The display area 49 is extended by virtue of a region 12c comprising additional information and buttons/slide controls for influencing the current media playback appearing between the region 12a and the region 12b. In order to affirm the temporary character of the extension of the display area 49 and the original anchoring of the display area 49 in the screen 4a, the region 12c is optically animated in the manner of an unfolding operation.

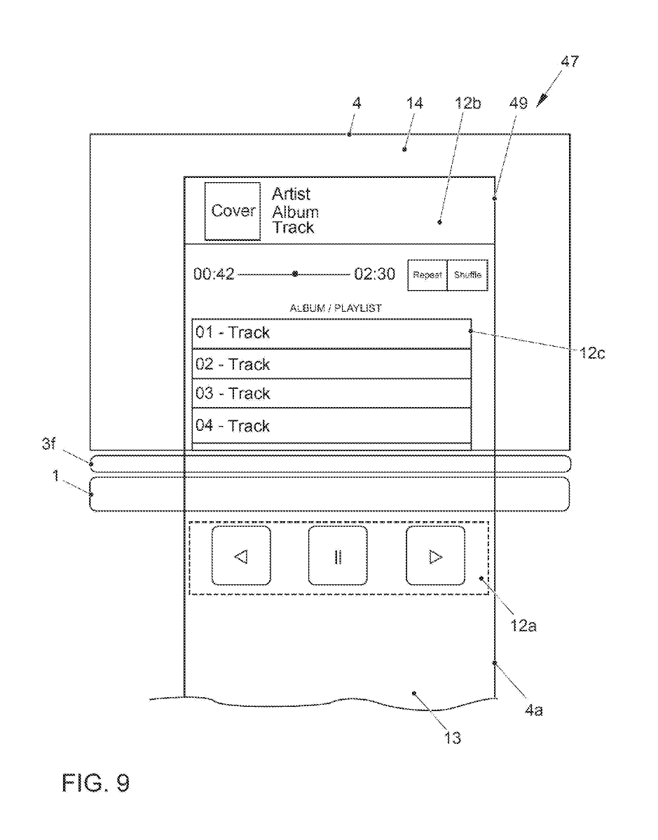

FIG. 9 shows the result of the user operating step which was started in FIG. 7 and was continued in FIG. 8 and as a result of which the display area 49 shows a completely unfolded region 12c in addition to the regions 12a, 12b. The direction of the user input (arrow P in FIG. 8) corresponds to the first direction according to the claims in which the screens 4, 4a are arranged behind one another or above one another. The screens 4, 4a clearly have different widths perpendicular to the main direction of extent of the finger strip 1, the screen 4a being narrower than the screen 4. That region of the display area 49 which extends on the second screen 4 is also limited with respect to a width and the position of its edges oriented parallel to the direction of the arrow P, in a manner corresponding to the screen 4a. In this case, the regions 12a, 12b, 12c are arranged closest to one another in such a manner that the display area 49 is not broken by off-topic display elements. Only the hardware elements of the finger strip 1 and the infrared LED strip 3a break the display area 49 which is otherwise in the form of a compact window. All regions of the display area 49 which are not associated with a separate function/button can be used to reverse the extension of the display area 49 by receiving a tapping gesture and to return to a configuration according to FIG. 7. A corresponding situation applies to second display contents 14 which are displayed on the screen 4 and are not assigned a separate operating function in the illustration according to FIG. 9.

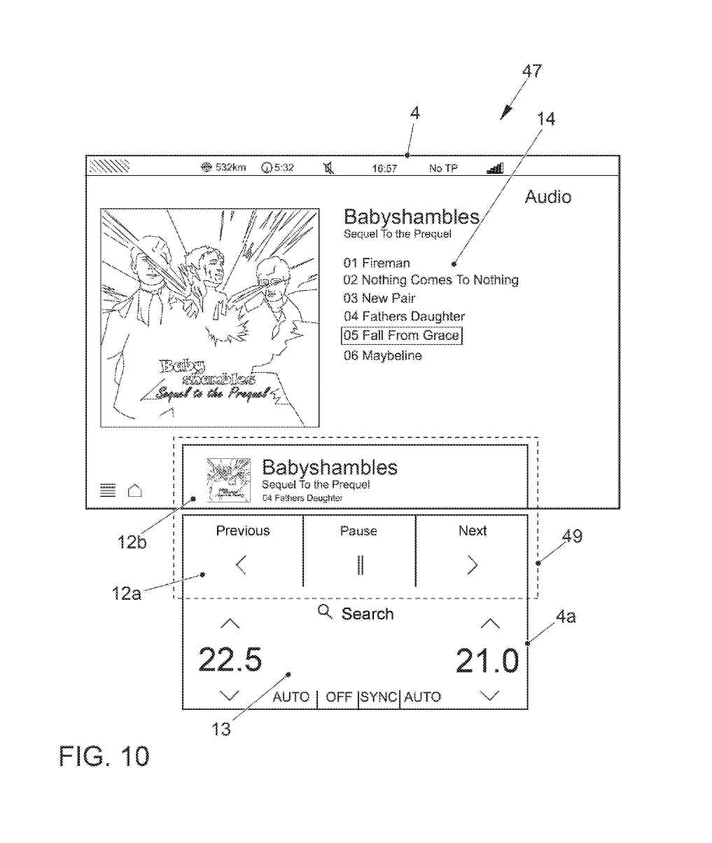

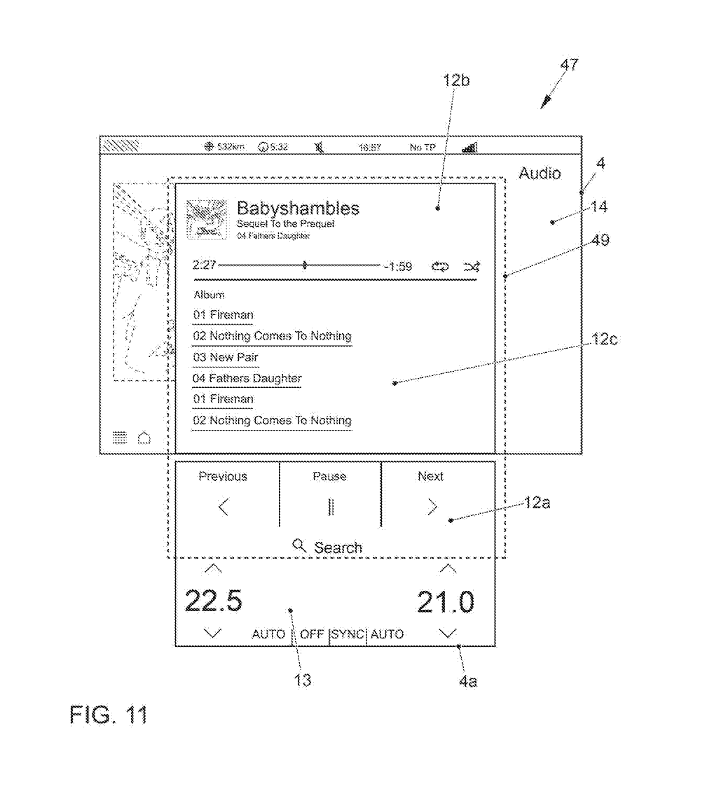

FIG. 10 shows an alternative illustration of a second exemplary embodiment of a surface of a user interface 47 according to the present disclosure. The air-conditioning operating ranges 13 within the screen 4a are in the form of buttons implement/decrement buttons for adapting an interior temperature for the driver's side/passenger side. Like the display area 49, the second display contents 14 of the screen 4 are associated with the current audio playback, but do not currently have any buttons for controlling the audio playback. The operating elements of the region 12a correspond substantially to those of the first exemplary embodiment (FIGS. 7-9), but have been extended with a “search” button. In the region 12b arranged on the second screen 4, the display area 49 has substantially the same information as that in the second display contents 14. Therefore, the region 12b is used substantially as a drag point for extending the display area 49. The region 12b can therefore be used to produce the arrangement of a display area 49 extended, as illustrated in FIG. 11, by receiving a tapping gesture or a swiping gesture started in the region 12b in the direction of the center of the screen 4.

FIG. 11 shows the result of an extension according to the invention of the display area 49 by a region 12c which has a list of tracks, buttons and a slide control for receiving additional user commands with respect to the media playback. The display area 49 is a window which, in comparison with the screen contents 14 previously displayed in a sharp, colored and bright manner, is optically clearly occupied by a focus on the screen 4 by virtue of the screen contents 14 now being displayed in a blurred or darkened manner and with reduced color saturation. A user input in the form of a swiping gesture in the region 12b, a tapping gesture on the region 12b or a tapping gesture on the screen contents 14 reverses the extension of the display area 49, with the result that the configuration illustrated in FIG. 10 is displayed again as a result.

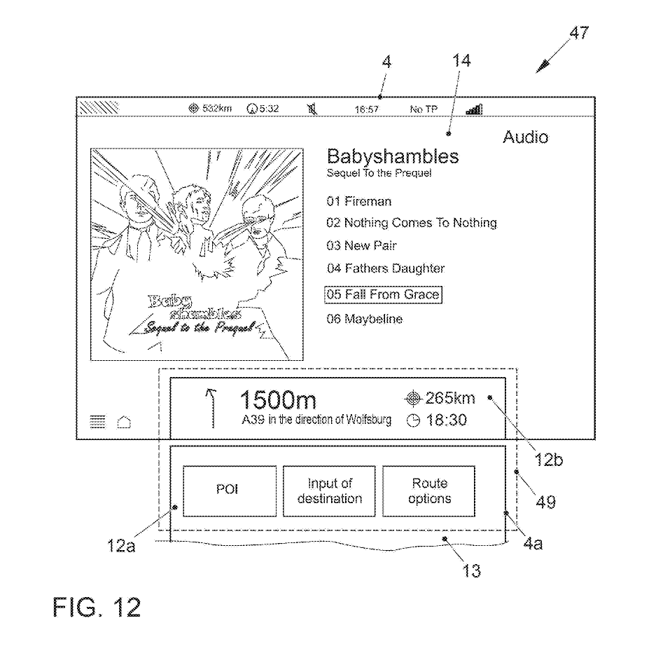

FIG. 12 shows a view of a third exemplary embodiment of a user interface 47 in which the display area 49 is associated with a group of functions associated with the topic of route guidance. The region 12a now shows buttons for inputting the destination, for calling up route options and for displaying nearby attractions. The region 12b shows comprehensive information relating to a current distance to the route destination, an expected arrival time and information relating to a next pending manoeuver. The remaining screen contents 14 of the screen 4 are associated with current media playback, in a manner corresponding to FIG. 10.

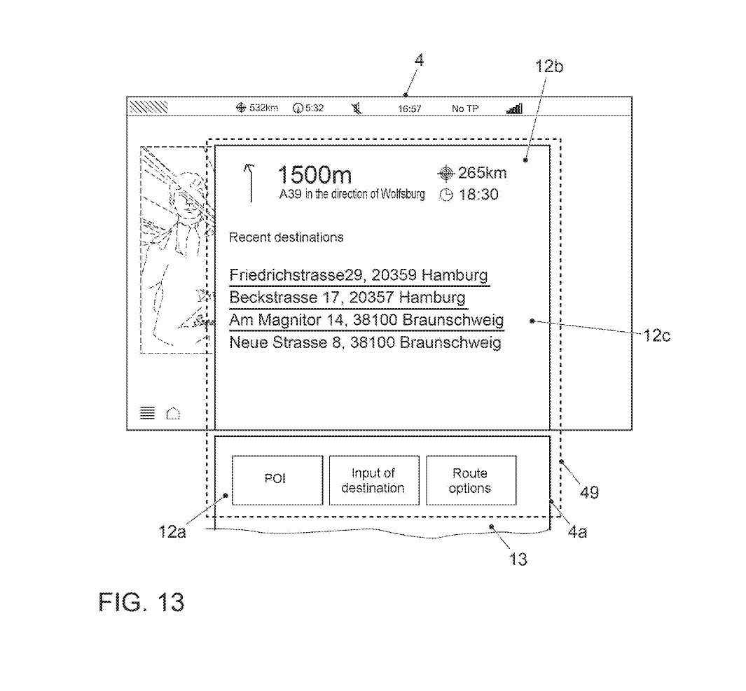

FIG. 13 shows the result of a tapping gesture (not illustrated) by a user on that region 12b of the display area 49 which is shown in FIG. 12. In response to the user input, the display area 49 on the second screen 4 is extended by inserting a region 12c in which a list of recent destinations is displayed and is held for selection. As described in connection with FIG. 11, the remaining screen contents 14 are displayed in a blurred or darkened manner and in a sepia color in response to the extension in order to underline the temporary character of the extension according to the invention of the display area 49 and to encourage the user to reverse the extension of the display area 49 by means of a tapping gesture on the screen contents 14.

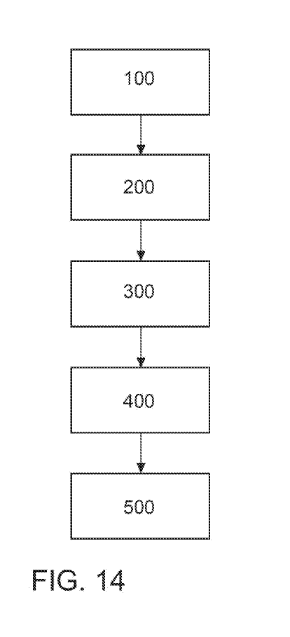

FIG. 14 shows a flowchart illustrating steps of a method for overlapping the display of display contents of a user interface of a transportation means. In step 100, first display contents are displayed on a first display device of the transportation means. Part of the display contents is also displayed on a second display device of the transportation means. In step 200, a predefined user input with respect to the first display contents is received. The predefined user input comprises a swiping gesture which starts on a surface within the first display contents and is oriented in the direction of a second display device of the transportation means. In response to this, an area associated with the first display contents on the second display device of the transportation means is extended in step 300. In other words, a boundary of the first display contents which is closest to the center of the second display device is moved in the direction of an edge of the second display device which is remote from the first display device. In step 400, a swiping gesture in the direction of the first display device is received in order to reduce the area of the first display contents on the second display device. The swiping gesture starts on the first display contents on the second display device. In response to this, the area associated with the first display contents on the second display device of the transportation means is reduced again in step 500. An interim blurred display and darkening of other screen contents displayed on the second display device is now reversed again in order to illustrate to the user the restored operability of these screen contents.

The trend in the cockpits of current transportation means, in particular motor vehicles, is currently heading to a design without switches. Since the intention is also to dispense with conventional rotary/pushbutton controllers in this case, as a result of which no significant haptic feedback follows user inputs, there is the need for a user interface and an input element which is integrated well in the optics of a cockpit without switches and nevertheless provides the customer with good orientation and optical feedback when adjusting important functions (for example audio volume, scrolling in long lists, climate control, etc.).

DE 10 2012 008 681 A1 discloses a multi-function operating device for a motor vehicle, in which a combined slider/touch surface is provided for the purpose of receiving swiping gestures and pressure inputs. The operating element is elongated or rectangular, a raised edge projection being used to guide the user's finger. The operating element is preferably arranged substantially vertically on the side of the screen display.

DE 10 2013 000 110 A1 discloses an operating method and an operating system in a vehicle, in which, in response to a touch-sensitive surface on a second display area being touched, buttons displayed on a first display area are changed in such a manner that additional information belonging to the button is displayed on the first display area. For this purpose, a touch-sensitive surface is provided for capacitive interaction with an actuation object (for example a capacitive touchscreen).

DE 10 2008 048 825 A1 discloses a display and operating system in a motor vehicle having user-adaptive display, a user input being able to be used to activate a modification mode in which all display objects are at least partially graphically displayed in a section of the display area. In this manner, objects previously distributed over an entire display area can be displayed in such a section which is within reach of a user.

Modern transportation means have a multiplicity of functions which can be displayed and operated via switches and screens. In an attempt to equip the interior of vehicles with as few switches as possible, contents and settings are being increasingly moved to increasingly larger display devices (for example touchscreens). As a result of the large area available, there is an increasing attempt by the developers to have the best possible flexibility for using the area and the best possible display/operating ergonomics for the user. In this case, approaches are also known for initially displaying display/operating elements associated with a particular function on a first display device in the transportation means and moving them to a second display device in response to a predefined user gesture. This makes it possible to comply with a user request to adapt the display position, for example.

WO 2010/042101 A1 discloses an infotainment system of a transportation means, having a screen which is proportionately arranged behind a steering wheel and on which display modules which are optically enclosed by the steering wheel rim are distinguished from display modules arranged outside the steering wheel rim. An information unit can be moved between the display modules in response to a predefined user input. A corresponding apparatus can be gathered from DE 10 2009 036 371 A1.

DE 10 2009 046 010 A1 discloses a vehicle information display having hierarchically structured information display levels. A particular information display level can be displayed via a user input.

Investigations have shown that freely selectable positions for information elements which can be displayed on different display devices can sometimes hinder the orientation of the user.

Even though the aspects according to the present disclosure and advantageous embodiments have been described in detail on the basis of the exemplary embodiments explained in conjunction with the accompanying figures of the drawing, modifications and combinations of features of the illustrated exemplary embodiments are possible for a person skilled in the art without departing from the scope of the present disclosure, the scope of protection of which is defined by the accompanying claims.

### LIST OF REFERENCE SYMBOLS

1 Finger strip
2 User
3 Detection unit
3a Capacitive antennas
3b Electronic components
3c Capacitive antennas (touching region)
3d Carrier
3e Circuit board of the detection unit
3f Infrared LED strip
4, 4a Screen
5 Electronic control unit
6 Data memory
7 Proximity sensor system
7a, 7b Ambient light strips
8a Driver's seat
8b Passenger seat
9 LED
10 Automobile
11 Web/frame part
12 Ledge
12a, 12b, 12c Regions of the display area
13 Heating/air-conditioning operating ranges
14 Screen contents/second display contents
40, 4a Display area
41, 42 Haptic limits
43, 44 End regions
45 Light outlet
46 Light guide
47 User interface
48 Loudspeaker
49 Display area/first display contents
100-500 Operating steps
P Arrow

1. A method for overlapping the display of display contents of a user interface of a transportation vehicle, comprising the steps of:
displaying first display contents on a first display device of the transportation vehicle,
receiving a predefined user input with respect to the first display contents, and, in response thereto, and
extending an area associated with the first display contents on a second display device of the transportation vehicle.

2. The method of claim 1, also comprising the steps of
displaying second display contents on the second display device of the transportation means.

3. The method of claim 2, wherein the first display contents has an edge which appears to be optically closed with respect to the second display contents on the second display device.

4. The method of claim 2, wherein the operation of extending the area associated with the first display contents to the second display device of the transportation means includes:
superimposing and/or replacing the second display contents on the second display device in a section of the second display device, and
continuously displaying the second display contents in other sections of the second display device.

5. The method of claim 4, wherein the second display contents is continuously displayed in other sections of the second display device in a modified optical display, the modified optical display including at least one of a blurred display, a dimmed display, a reduced display, and a reduced color saturation.

6. The method of claim 2, also comprising
receiving at least one of
a swiping gesture in the direction of the first display device, and
a tapping gesture on the second display contents on the second display device, and
in response thereto
reducing the area associated with the first display contents on the second display device of the transportation vehicle.

7. A user interface for a transportation vehicle, comprising
a first display device,
a second display device
a detection unit for detecting user gestures, and
an evaluation unit,
wherein the first display device is set up to display first display contents,
wherein the detection unit is set up to receive a predefined user input with respect to the first display contents, and
wherein the evaluation unit is set up, in response to the detection of the predefined user input, to extend an area associated with the first display contents on the second display device of the transportation vehicle.

8. The user interface of claim 7, wherein the first display device and the second display device is arranged below one another or beside one another with respect to a first direction, and has at least one of different sizes and aspect ratios.

9. The user interface of claim 7, wherein a width of the first display device with respect to the first direction is smaller than a width of the second display device with respect to the first direction, and the area associated with the first display contents on the second display device is extended only to the width of the first display device.

10. The user interface of claim 7, wherein an area associated with the first display contents on the first display device is arranged closest to the second display device, and an area associated with the first display contents on the second display device is arranged closest to the first display device.

11. The user interface as claimed in one of claims 7 to 10 of claim 7, wherein the predefined user input includes at least one of
a swiping gesture in the direction of a center of the second display device, and
a tapping gesture on a button which is displayed in one of a region of the second display device which is closest to the first display device and a region of the first display device which is closest to the second display device.

12. A computer program product comprising instructions which, when executed on an evaluation unit of a user interface including a first display device, a second display device, a detection unit for detecting user gestures, and an evaluation unit, wherein the first display device is set up to display first display contents, the detection unit is set up to receive a predefined user input with respect to the first display contents, and the evaluation unit is set up, in response to the detection of the predefined user input, to extend an area associated with the first display contents on the second display device of the transportation vehicle, cause the evaluation unit to carry out the steps of:
displaying first display contents on a first display device of the transportation vehicle,
receiving a predefined user input with respect to the first display contents, and, in response thereto, and
extending an area associated with the first display contents on a second display device of the transportation vehicle.

13. (canceled)

14. A transportation vehicle comprising a user interface including
a first display device, a second display device,
a detection unit for detecting user gestures, and
an evaluation unit,
wherein the first display device is set up to display first display contents, the detection unit is set up to receive a predefined user input with respect to the first display contents, and the evaluation unit is set up, in response to the detection of the predefined user input, to extend an area associated with the first display contents on the second display device of the transportation vehicle.
